(19) United States
(12) Patent Application Publication
(10) Pub. No.: US 2003/0168982 A1
(43) Pub. Date: Sep. 11, 2003

(54) Light bulb for a electrodeless discharge lam

(76) Inventor: Jin-Joong Kim, Cheonan-shi (KR)

Correspondence Address: YOUNG & THOMPSON, 745 SOUTH 23RD STREET 2ND FLOOR, ARLINGTON, VA, 22202

(21) Appl. No.: 10/344,233

(22) PCT Filed: Jun. 11, 2001
(86) PCT No.: PCT/KR01/00995

(30) Foreign Application Priority Data
Aug. 25, 2000 (KR) 2000-49590

(51) Int. Cl. H01J 17/16; H01J 61/30

(52) U.S. Cl. 313/634

(57) ABSTRACT

The present invention relates to a bulb for the electrodes discharge lamp, which, for the purpose of completely blocking the diffusion of heat caused by the convection of air from contact with the discharge bulb or other ways of transfer of heat, is equipped with another, external bulb to contain the discharge bulb inside but removed from it by a vacuous space in-between, and has a reflector formed by coating some of the outer surface of the external bulb for condensation or throw-back of light, whereby dispensing with attachment of a separate lamp shade. In the present invention, the discharge bulb to be contained in the above-said external lamp can be in a plural number so that sources of light of high brightness may be provided, and the external lamp also can be structured in plural numbers so that a variety of uses may satisfactorily be made of.

### BACKGROUND OF THE INVENTION

1. Field of the Invention

The present invention relates to a light bulb for an electrodeless discharge lamp which emits light by radio wave or microwave discharging and is used in an electrodeless discharge lamp for high luminescence lighting, electrodeless plasma lamp and industrial ultraviolet light lamp.

2. Description of Related Art

The high pressure discharge lamp uses high frequency wave of 1˜100 MHz(radio wave) or ultra high frequency wave of 300 MHz˜30 GHz(microwave) to generate light. Because of its high efficiency and large output the application of the high pressure discharge lamp is widening as a point source of light such as a light source of LCD video projector. Also, due to high efficiency and high color rendering, it is used for the lighting of relay broadcasting of sports for high definition TV and for large scale lighting at the place such as museum, art gallery, large factory or airport.

Among them, the discharge lamp such as radio wave electrodeless discharge yellow lamp shows much more efficiency than the arc discharge lamp with electrode, and has the advantage of eliminating mercury from the fill materials for discharge lighting. And since there is no need of metal electrode inside the discharge space, blackening of inner wall of valve due to the evaporation of electrode does not occur. Therefore, the life of lamp is nearly permanent and the period of color rendering is much longer than conventional discharge lamp with electrode. Due to these characteristics, much research is being made on the next generation high pressure discharge lamp.

The prior art electrodeless discharge lamp uses a single bulb of spherical shape to discharge in the air for discharge lighting. But it is difficult to form a closed high luminescent electrodeless lamp system since heat is dispersed by convection current of air contacting the bulb or by direct conduction of heat to air.

In the prior art, luminescent material such as sulfur or mercury is mixed with inert gas in a single quartz sphere with diameter of about 3 cm and discharging is occurred in the cavity surrounded by the wire net in which radio wave or microwave can be resonant to generate high luminescence white light or ultraviolet light.

When this single bulb is discharged in the air, the temperature of the discharge bulb rises above 900 degrees centigrade and the air contacting the bulb is heated resulting in convection current of hot air and direct conduction of heat to air. Because of this convection current of hot air, heat is dispersed and it is very difficult to process peripheral device for high temperature. Also, because this dispersion of heat makes it impossible to form a closed cap of lamp, there is needed a large cap outside the metal cavity which includes discharge vessel in order to condense or transmit light.

### SUMMARY OF THE INVENTION

To overcome the above mentioned problems of prior art discharge lamp, one object of the present invention is to provide a light bulb for a multiple structured electrodeless discharge lamp.

Another object of the present invention is to provide an electrodeless discharge lamp which does not disperse heat by convection current or conduction of air.

Still another object of the present invention is to provide an electrodeless discharge lamp which incorporates reflector means in the bulb of an electrodeless discharge lamp for condensing and transmitting light.

To accomplish these objects, the electrodeless discharge lamp of the present invention includes separate outer bulb outside the discharge vessel with one side of the outer surface of the outer bulb arranged as a reflector and the shape and number of discharge vessel are diversified.

### BRIEF DESCRIPTION OF THE DRAWINGS

FIG. 1 is a schematic diagram showing the structure of prior art electrodeless discharge lamp,

FIG. 2 is a cross sectional view of prior art electrodeless discharge lamp,

FIG. 3 is a cross sectional view of the first embodiment of the present invention,

FIG. 4 is a cross sectional view of the second embodiment of the present invention,

FIG. 5 is a horizontal cross sectional view of the third embodiment of the present invention,

FIG. 6 is a vertical cross sectional view of the third embodiment of the present invention,

FIG. 7 is a horizontal cross sectional view of the fourth embodiment of the present invention,

FIG. 8 is a vertical cross sectional view of the fourth embodiment of the present invention, and

FIG. 9 is a vertical cross sectional view of the fifth embodiment of the present invention.

### DESCRIPTION OF IMPORTANT PARTS OF THE DRAWINGS

1, 1′, 1″: discharge vessel

2: supporting pole

11, 11′, 11″: outer bulb

12: reflector

21: waveguide

22: wire net

### BEST MODE FOR CARRYING OUT THE INVENTION

The present invention will now be described in detail with reference to the attached drawings.

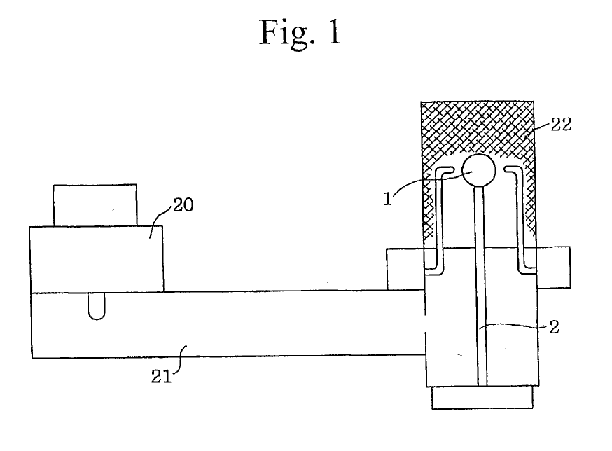

FIG. 1 illustrates the structure of prior art electrodeless discharge lamp with rotational discharge vessel attached thereof As shown in the figure, prior art electrodeless discharge lamp comprises high frequency wave generator 20 such as magnetron which generates radio wave or microwave, waveguide 21 connected to the wave generator 20, and a rotatable (or not rotatable) discharge vessel 1 installed in a cavity connected to the waveguide 21 and surrounded by wire net 22, and the discharge vessel filled with luminescent material such as sulfur or mercury mixed with inert gas such as argon.

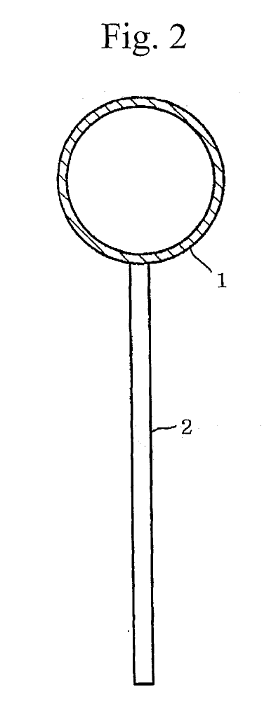

FIG. 2 illustrates the structure of discharge vessel of prior art discharge lamp of FIG. 1. As shown in the figure, prior art discharge vessel has the structure of single spherical discharge vessel supported by supporting pole 2 with the same insulating material such as quartz. Therefore, discharge vessel is directly in contacted with external air so that there is heat dispersion due to the convection current of air and direct conduction of heat to air. Also, since it has the structure of a single discharge vessel, there is needed a separate lamp cap.

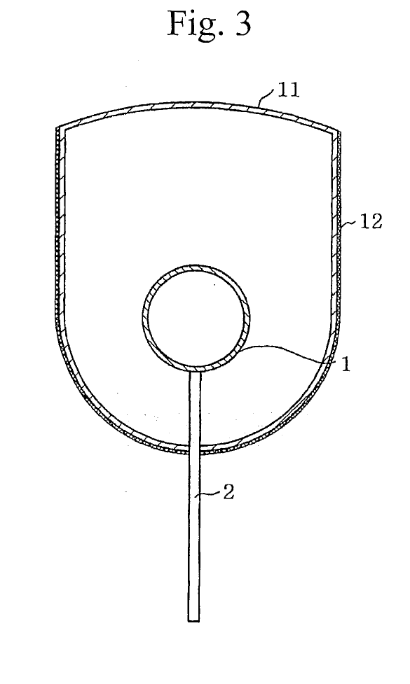

FIG. 3 is a cross sectional view of bulb according to the first embodiment of the present invention As shown in the figure, outer bulb 11 is installed outside the discharge vessel 1 and vacuum is formed between discharge vessel 1 and outer bulb 11. The outer bulb 11 is mounted and fixed on the supporting pole 2 in the same way as the discharge vessel.

Also, a reflector 12 can be formed for condensing or transmitting light by coating thin film of reflecting dielectric material on one side of outer surface of outer bulb 11 of the present invention, preferably on the rear outer surface of outer bulb 11 except front surface. By this reflector, light generated from discharge vessel is projected to the fore direction and there is no need of separate lamp cap.

As readily can be seen the reflector 12 can be disposed anywhere on the outer bulb and curvature can vary according to the need of application, and these variations are also within the scope of the present invention.

According to the present invention, by forming vacuum between the outer bulb 11 and light source discharge vessel 1, heat generated from the discharge vessel is not dispersed by the convection current of the air so preventing peripheral device from heating.

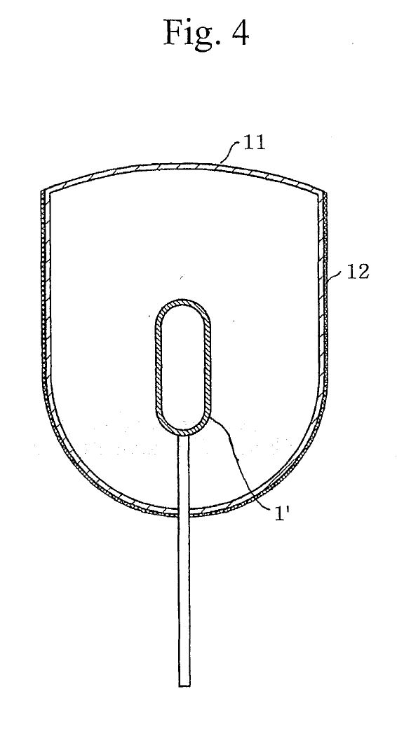

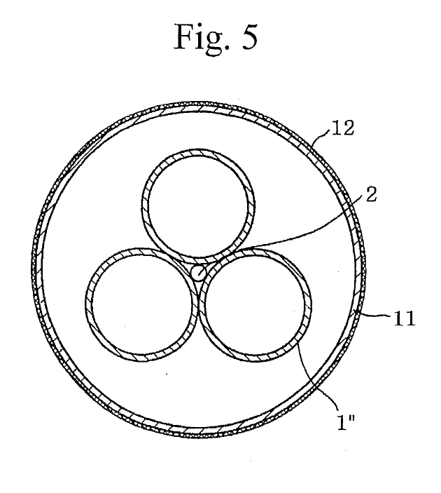

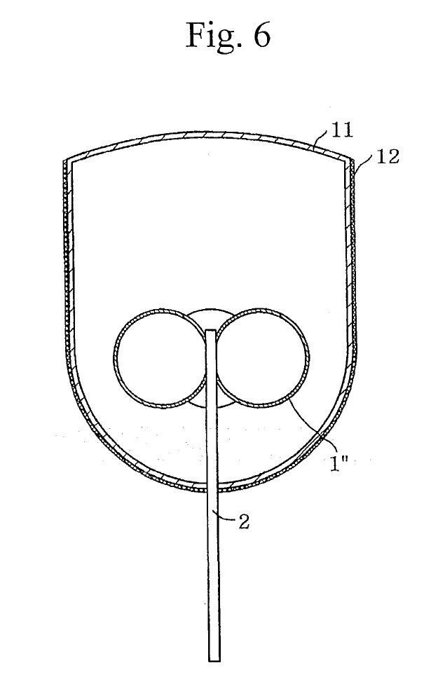

FIG. 4 is a vertical cross sectional view of the second embodiment of the present invention. As shown in the figure, the discharge vessel 1′ of the present invention which is installed inside the outer bulb 11 is formed in the form of cylinder with its vertical cross section forming a long ellipse so that the luminescent material in the bulb can be discharged more easily. FIG. 5 is a horizontal cross sectional view of the third embodiment of the present invention and FIG. 6 a vertical sectional view of the third embodiment of the present invention. As shown in the figure, the structure of the discharge vessel installed inside the outer bulb 11 is modified. In this embodiment, a plurality of discharge Vessels 1″ are installed inside the outer bulb 11. The purpose is to provide modification of color rendering by mixing two or more of spectrums.

These discharge vessels 1″ are preferably supported by support pole 2 and act as separate light sources making it possible to modify color rendering. The size of the bulb can be modified as needed.

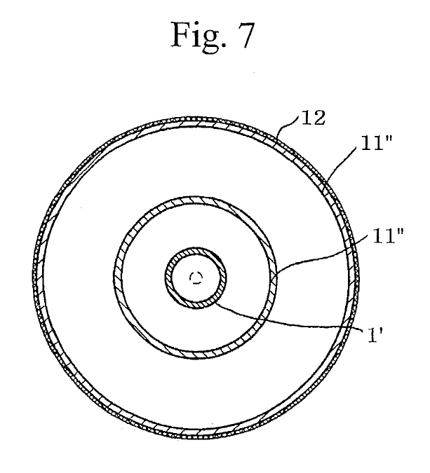

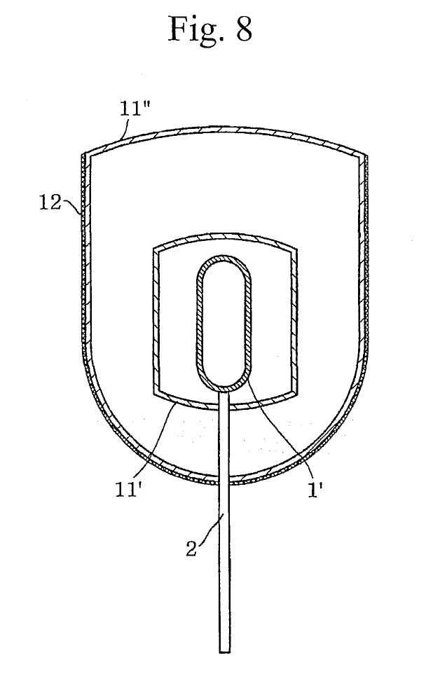

FIG. 7 is a horizontal cross sectional view of the fourth embodiment of the present invention anid FIG. 8 is a vertical sectional view of the fourth embodiment of the present invention. According to the embodiment of the present invention, a plurality of outer bulbs are formed and have the structure of multilayered outer bulbs. As shown in the figure, a plurality of outer bulbs 11′, 11″ are installed outside the discharge vessel 1′ or 1 forming layers, each outer bulb installed so that there is a space between them.

Between said discharge vessel 1′ and corresponding innermost outer bulb 11′, certain fill material can be filled to make it possible to generate light and the space between outermost outer bulb 11′ and neighboring outer bulb 11 is preferably a vacuum. As readily can be seen, the number of outer bulbs can be modified as needed and it is possible to use more than three outer bulbs.

Also, in these multilayered outer bulbs, the outer surface of outermost outer bulb is preferably a reflector.

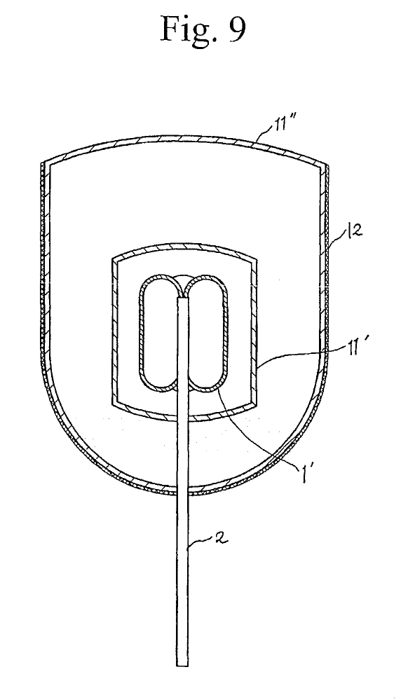

FIG. 9 is a vertical cross sectional view of the fifth embodiment of the present invention. As shown in the figure, the fifth embodiment of the present invention comprises a plurality of discharge vessels 1″ as the third embodiment of the present invention which is installed in the multilayered outer bulbs as in the fourth embodiment.

The discharge bulb using the structure of the present invention, as described above, can be used by inserting the discharge bulb in a cavity of metal wire net in the shape of cylinder or other shape connected to the radio wave or microwave waveguide, or in a cavity composed of closed cylinder and metal lid.

Industrial Applicability

According to the present invention, as described above, vacuum is formed between discharge vessel and outer bulb so that heat is not dispersed by convection current or conduction of heat to air reducing electric power consumption and preventing high temperature convection current around discharge vessel.

In addition, since heat is emitted from the bulb by radiation only, it is possible to form a closed bulb body.

According to the present invention, outer surface of outer bulb can be used as reflector providing the effect of forming compact and simple high luminescent lamp cap system for lighting. Therefore, it is possible to construct a compact system for transmit lighting, general lighting or industrial high luminescent UV processing.

According to the present invention, by using a plurality of discharge lamps, it is also possible to provide light sources of different spectrum for color rendering needed.

Moreover, by using double or multiple structure of lamp, color rendering of light lamp can be varied as needed, and since there is no cooling the first lamp, electiomagnetic wave density required to reach the temperature which is sufficient for lighting of light discharging gas or vapor is lower than prior art method.

Also, since there is no need of large lamp cap, it is possible to construct small and compact electrodeless discharge lamp. Finally, there is no conduction or convection current of heat and radiant light is completely emitted by reflector, so there is no need of complex cooling device for lamp.

As described above, the discharge bulb of the present invention provides many effects in application.

What is claimed is:

1. A light bulb for in electrodeless discharge lamp, which is installed in the cavity connected to a waveguide for radio wave or microwave and includes discharge vessel 1 containing luminescent material mixed with inert gas to generate discharging, said discharge vessel 1 installed inside an outer bulb 11.

2. The light bulb for an electrodeless discharge lamp of claim 1, wherein said discharge vessel is in the form of cylinder.

3. The light bulb for an electrodeless discharge lamp of claim 1, wherein vacuum is formed between said outer bulb and said discharge vessel.

4. The light bulb for an electrodeless discharge lamp of claim 1, wherein a plurality of outer bulbs form layers with predetermined distance between the layers.

5. The light bulb for an electrodeless discharge lamp of one of claims 1 to 4, which includes a plurality of discharge vessels.

6. The light bulb for an electrodeless discharge lamp of one of claims 1 to 4, wherein thin film of reflecting dielectric material is coated on the outer surface of one side of said outer bulb to form a reflector.

7. The light bulb for an electrodeless discharge lamp of claims 6, wherein thin film of reflecting dielectric material is coated on the outer surface of one side of said outer bulb to form a reflector.
